(19) United States
(12) Patent Application Publication
(10) Pub. No.: US 2023/0073217 A1
(43) Pub. Date: Mar. 9, 2023

(54) OPTICAL COMPENSATION ELEMENT, METHOD FOR MANUFACTURING OPTICAL COMPENSATION ELEMENT, LIQUID CRYSTAL DISPLAY DEVICE, AND ELECTRONIC APPARATUS

(71) Applicant: SONY SEMICONDUCTOR SOLUTIONS CORPORATION, KANAGAWA (JP)

(72) Inventors: TAKUMA MATSUNO, KUMAMOTO (JP); TAKASHI SAKAIRI, KANAGAWA (JP); KEIICHI MAEDA, KANAGAWA (JP)

(21) Appl. No.: 17/793,443

(22) PCT Filed: Dec. 18, 2020
(86) PCT No.: PCT/JP2020/047398

§ 371 Date: Jul. 18, 2022

(30) Foreign Application Priority Data
Jan. 24, 2020 (JP) 2020-009935

(51) Int. Cl. G02F 1/13363; G03B 21/00

(52) U.S. Cl. CPC G02F 1/13363; G03B 21/006

(57) ABSTRACT

A liquid crystal display device includes:
a pair of substrates (100, 200);
a liquid crystal material layer (300) sandwiched between the pair of substrates; and
an optical compensation element (220) having an optical compensation film (224).

The optical compensation element includes: a base layer (221) having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

### TECHNICAL FIELD

The present disclosure relates to an optical compensation element, a method for manufacturing the optical compensation element, a liquid crystal display device, and an electronic apparatus.

### BACKGROUND ART

A liquid crystal display device having a configuration in which a liquid crystal material layer is sandwiched between a pair of substrates is known. The liquid crystal display device displays an image by causing a pixel to act as an optical shutter (light valve). In recent years, for the liquid crystal display device, an increase in luminance and an increase in contrast have been required in addition to an increase in definition.

As a means for increasing the contrast, it is known to use an optical compensation element having an optical compensation film that compensates for refractive index anisotropy by a liquid crystal material layer. In a case of a liquid crystal display device in which liquid crystal molecules are initially aligned substantially perpendicularly to a substrate surface, usually, an optical compensation element constituting an O-plate for compensating for an influence of a tilt angle inclination component in the liquid crystal molecules, and an optical compensation element constituting a C-plate for compensating for refractive index anisotropy of a liquid crystal material layer are used. The C-plate is usually formed on a surface on a liquid crystal material layer side in a transistor array substrate or a counter substrate. Meanwhile, the O-plate is often disposed outside the substrate as a separate member.

It is basically preferable to form an optical compensation element in a substrate constituting a liquid crystal display device from a viewpoint of enhancing an effect of optical compensation. Therefore, it has been proposed to use an optical compensation element including a stacked film obtained by alternately and repeatedly stacking layers on a base layer in which a plurality of fine inclined surfaces is formed (see, for example, Patent Document 1).

### CITATION LIST

### Patent Document

Patent Document 1: PCT International Application Laid-Open No. 2018/042912

### SUMMARY OF THE INVENTION

### Problems to be Solved by the Invention

As a method for forming the base layer in which a plurality of fine inclined surfaces is formed, a method for exposing a resist film to light using a halftone mask and then performing an etching process on the resist film, a method for transferring a fine inclined surface to a resist film by a nanoimprint technique and then performing an etching process on the resist film, and the like are considered. However, in the former, there is a limit to reducing a pitch on the inclined surface. Furthermore, in the latter, there is a problem such as machine tact due to a step-and-repeat process.

Therefore, an object of the present disclosure is to provide an optical compensation element that can form an inclined surface at a fine pitch and is also good in terms of machine tact, a method for manufacturing the optical compensation element, a liquid crystal display device including the optical compensation element, and an electronic apparatus including the liquid crystal display device.

### Solutions to Problems

An optical compensation element according to the present disclosure for achieving the above object includes:

a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

A method for manufacturing an optical compensation element according to the present disclosure for achieving the above object includes:

a step of forming a set of a plurality of grooves having different depths on a surface of a base body at a predetermined pitch;

a step of, subsequently, repeatedly performing a film forming process and an etching process on the surface to form a base layer having a serrated cross-sectional shape; and

a step of alternately forming a high refractive index film and a low refractive index film on the base layer to form an optical compensation film.

A liquid crystal display device according to the present disclosure for achieving the above object includes:

a pair of substrates;

a liquid crystal material layer sandwiched between the pair of substrates; and

an optical compensation element having an optical compensation film, in which

the optical compensation element includes: a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

An electronic apparatus according to the present disclosure for achieving the above object includes a liquid crystal display device including:

a pair of substrates;

a liquid crystal material layer sandwiched between the pair of substrates; and

an optical compensation element having an optical compensation film, in which

the optical compensation element includes: a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

### BRIEF DESCRIPTION OF DRAWINGS

FIG. 1 is a schematic diagram for explaining a liquid crystal display device according to the present disclosure.

FIG. 2A is a schematic cross-sectional view for explaining a basic configuration of the liquid crystal display device. FIG. 2B is a schematic circuit diagram for explaining a pixel in the liquid crystal display device.

FIG. 3 is a schematic partial cross-sectional view for explaining the liquid crystal display device according to the present disclosure.

FIG. 4 is a schematic plan view for explaining a relationship among a region where a pixel is formed, a region where an optical compensation element is formed, and a region where a light shielding portion is formed in the liquid crystal display device according to the present disclosure.

FIG. 5 is a schematic diagram for explaining optical compensation in a liquid crystal display device according to a first embodiment.

FIG. 6A is a schematic perspective view for explaining a base layer having a serrated cross-sectional shape. FIG. 6B is a schematic partial cross-sectional view for explaining an optical compensation element including an optical compensation film formed on the base layer.

FIGS. 7A, 7B, and 7C are schematic partial cross-sectional views for explaining a method for manufacturing an optical compensation element.

FIGS. 8A, 8B, and 8C are schematic partial cross-sectional views for explaining the method for manufacturing an optical compensation element, following FIG. 7C.

FIGS. 9A, 9B, and 9C are schematic partial cross-sectional views for explaining the method for manufacturing an optical compensation element, following FIG. 8C.

FIGS. 10A, 10B, and 10C are schematic partial cross-sectional views for explaining the method for manufacturing an optical compensation element, following FIG. 9C.

FIGS. 11A and 11B are schematic partial cross-sectional views for explaining the method for manufacturing an optical compensation element, following FIG. 10C.

FIGS. 12A and 12B are schematic partial cross-sectional views for explaining a modification of a set of a plurality of grooves having different depths, formed on a surface of a base body.

FIGS. 13A and 13B are schematic partial cross-sectional views for explaining a method for manufacturing an optical compensation element of a modification.

FIGS. 14A and 14B are schematic partial cross-sectional views for explaining the method for manufacturing the optical compensation element of the modification, following FIG. 13B.

FIG. 15 is a conceptual diagram of a projection type display device.

FIG. 16 is an external view of a lens interchangeable single-lens reflex type digital still camera, in which FIG. 16A illustrates a front view thereof, and FIG. 16B illustrates a rear view thereof.

FIG. 17 is an external view of a head mounted display.

FIG. 18 is an external view of a see-through head mounted display.

FIG. 19 is a block diagram illustrating an example of a schematic configuration of a vehicle control system.

FIG. 20 is an explanatory diagram illustrating an example of positions where an outside-vehicle information detecting section and an imaging section are disposed.

### MODE FOR CARRYING OUT THE INVENTION

Hereinafter, the present disclosure will be described with reference to the drawings on the basis of an embodiment. The present disclosure is not limited to the embodiment, and various numerical values and materials in the embodiment are examples. In the following description, the same reference signs will be used for the same elements or elements having the same functions, and redundant description will be omitted. Note that description will be made in the following order.

1. General description of optical compensation element, method for manufacturing optical compensation element, liquid crystal display device, and electronic apparatus according to the present disclosure

2. First embodiment and modification

3. Description of electronic apparatus

4. Application examples and others

### [General Description of Optical Compensation Element, Method for Manufacturing Optical Compensation Element, Liquid Crystal Display Device, and Electronic Apparatus According to the Present Disclosure]

In the following description, a liquid crystal display device according to the present disclosure and a liquid crystal display device included in an electronic apparatus according to the present disclosure may be simply referred to as a [liquid crystal display device of the present disclosure]. Furthermore, an optical compensation element according to the present disclosure, an optical compensation element obtained by a method for manufacturing an optical compensation element according to the present disclosure, and an optical compensation element used in a liquid crystal display device of the present disclosure may be simply referred to as an [optical compensation element of the present disclosure].

As described above, the optical compensation element of the present disclosure includes: a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

In this case, each of the high refractive index film and the low refractive index film may include an inorganic insulating material. Examples of a material constituting the high refractive index film include silicon nitride (SiNₓ), tantalum oxide (Ta₂O₅), and titanium oxide (TiO₂). Furthermore, examples of a material constituting the low refractive index film include silicon oxide (SiOₓ) and silicon oxynitride (SiOₓN_{y}). Preferably, each of the high refractive index film and the low refractive index film preferably includes any one of silicon oxide, silicon nitride, and silicon oxynitride from a viewpoint of commonality of a manufacturing process or the like.

It is only required to appropriately set the film thicknesses and the number of stacked layers of each of the high refractive index film and the low refractive index film according to the specifications of the optical compensation film. For example, the film thickness can be about 10 to 50 nanometers. It is only required to set a film thickness ratio between the high refractive index film and the low refractive index film to approximately 1:1. It is only required to set the number of stacked layers for these films to, for example, about 10 to 200. The high refractive index film and the low refractive index film can be formed by, for example, a known film forming method such as a CVD method or a PVD method.

In the optical compensation element of the present disclosure including the above-described various preferable configurations, an arrangement pitch of the set of the plurality of grooves having different depths is preferably shorter than the wavelength of visible light. More preferably, the arrangement pitch is desirably 300 nanometers or less.

In the optical compensation element of the present disclosure including the above-described various preferable configurations, a part of the base layer can be periodically removed such that an arrangement pitch of the base layer is shorter than an arrangement pitch of the set of the plurality of grooves having different depths. According to this configuration, the arrangement pitch of the base layer can be made shorter.

As described above, the liquid crystal display device of the present disclosure includes a pair of substrates, a liquid crystal material layer sandwiched between the pair of substrates, and an optical compensation element having an optical compensation film. As the pair of substrates, a transistor array substrate and a counter substrate that is disposed so as to face the transistor array substrate can be included.

In this case, the optical compensation element can be disposed in at least one of the counter substrate or the transistor array substrate. For example, the optical compensation film can be disposed in the counter substrate, or the optical compensation film can be disposed in the transistor array substrate.

Alternatively, the optical compensation film can be disposed in each of the counter substrate and the transistor array substrate.

Alternatively, in this case, a black matrix and/or a microlens can be formed in at least one of the counter substrate or the transistor array substrate.

As described above, a method for manufacturing an optical compensation element according to the present disclosure includes:

a step of forming a set of a plurality of grooves having different depths on a surface of a base body at a predetermined pitch;

a step of, subsequently, repeatedly performing a film forming process and an etching process on the surface to form a base layer having a serrated cross-sectional shape; and

a step of alternately forming a high refractive index film and a low refractive index film on the base layer to form an optical compensation film. As the base body, for example, a substrate or an insulating material layer formed thereon can be used. The plurality of grooves having different depths can be formed by a combination of a known film forming method and a known patterning method such as an etching method or a lift-off method.

In this case, the step of repeatedly performing a film forming process and an etching process on the surface to form a base layer having a serrated cross-sectional shape can be performed by performing high density plasma CVD on the surface. In the high density plasma CVD, since the film forming process and the etching process proceed substantially concurrently, the base layer can be efficiently formed.

The method for manufacturing an optical compensation element according to the present disclosure including the above-described preferable configurations can further include a step of periodically removing a part of the base layer such that an arrangement pitch of the base layer is shorter than an arrangement pitch of the set of the plurality of grooves having different depths. According to this configuration, the arrangement pitch of the base layer can be made shorter.

In a case of a transistor array substrate used in a transmissive liquid crystal display device, a pixel electrode can be formed using a transparent conductive material such as indium tin oxide (ITO) or indium zinc oxide (IZO). In a case of a transistor array substrate used in a reflective liquid crystal display device, a pixel electrode can be formed using, for example, a metal material such as a metal including aluminum (Al) and silver (Ag) or an alloy thereof. Note that, in some cases, a pixel electrode can be formed by stacking the transparent conductive material described above and these metal materials.

As the transistor array substrate, a substrate including a transparent material such as plastic, glass, or quartz, or a substrate including a semiconductor material such as silicon can be used. A transistor constituting a switching element can be constituted by, for example, forming and processing a semiconductor material layer or the like on a substrate.

As the counter substrate, a substrate including a transparent material such as plastic, glass, or quartz can be used. In the counter substrate, a counter electrode can be formed using a transparent conductive material such as indium tin oxide (ITO) or indium zinc oxide (IZO). The counter electrode functions as a common electrode for pixels of the liquid crystal display device.

A material constituting various kinds of wiring, an electrode, or a contact is not particularly limited, and for example, a metal material such as aluminum (Al), an aluminum alloy including Al—Cu and Al—Si, tungsten (W), or a tungsten alloy including tungsten silicide (WSi) can be used.

A material constituting an interlayer insulating layer, a planarization film, or the like is not particularly limited, and an inorganic material such as silicon oxide, silicon oxynitride, or silicon nitride, and an organic material such as polyimide can be used.

A method for forming a semiconductor material layer, wiring, an electrode, an insulating layer, an insulating film, or the like is not particularly limited, and these can be formed using a known film forming method as long as there is no problem in carrying out the present disclosure. The same applies to a method for patterning these.

The liquid crystal display device may be configured to display a monochrome image or a color image. Examples of a value of a pixel of the liquid crystal display device include some image resolutions such as (3840, 2160) and (7680, 4320) in addition to U-XGA (1600, 1200), HD-TV (1920, 1080), and Q-XGA (2048, 1536), but the value is not limited to these values.

Furthermore, examples of the electronic apparatus including the liquid crystal display device of the present disclosure include various electronic apparatuses each having an image display function in addition to a direct view type or projection type display device.

Various conditions in the present specification are satisfied not only in a case where the conditions are strictly satisfied but also in a case where the conditions are substantially satisfied. Presence of various variations caused by design or manufacturing is allowed. Furthermore, the drawings used in the following description are schematic, and do not indicate actual dimensions or ratios thereof.

### First Embodiment

A first embodiment relates to an optical compensation element, a liquid crystal display device, and an electronic apparatus according to the present disclosure.

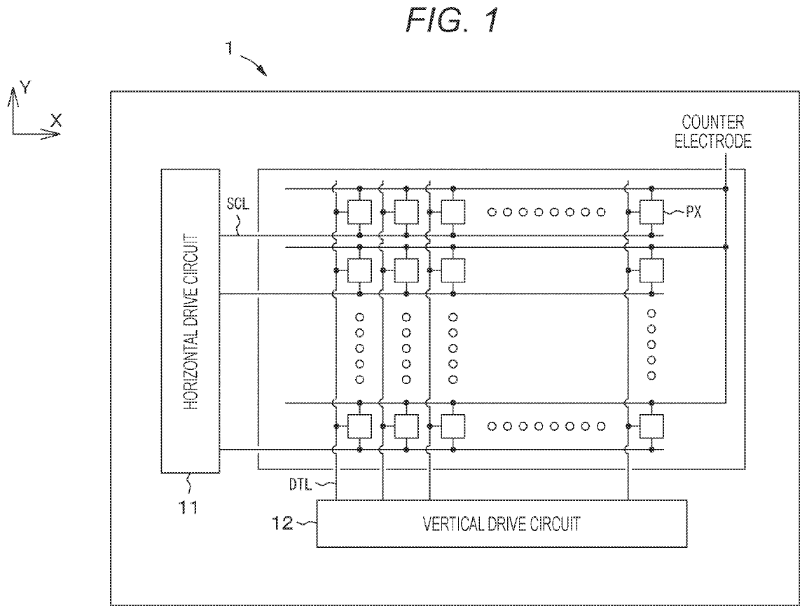

FIG. 1 is a schematic diagram for explaining a liquid crystal display device according to the present disclosure.

The liquid crystal display device according to the first embodiment is an active matrix type liquid crystal display device. As illustrated in FIG. 1, a liquid crystal display device 1 includes various circuits such as pixels PX arranged in a matrix, and a horizontal drive circuit 11 and a vertical drive circuit 12 for driving the pixels PX. A reference sign SCL denotes a scanning line for scanning the pixel PX, and a reference sign DTL denotes a signal line for supplying various voltages to the pixel PX. For example, M pixels PX are arranged in the horizontal direction, N pixels PX are arranged in the vertical direction, and M×N pixels PX in total are arranged in a matrix. A counter electrode illustrated in FIG. 1 is disposed as a common electrode for liquid crystal cells. Note that, in the example illustrated in FIG. 1, each of the horizontal drive circuit 11 and the vertical drive circuit 12 is disposed on one end side of the liquid crystal display device 1, but this is merely an example.

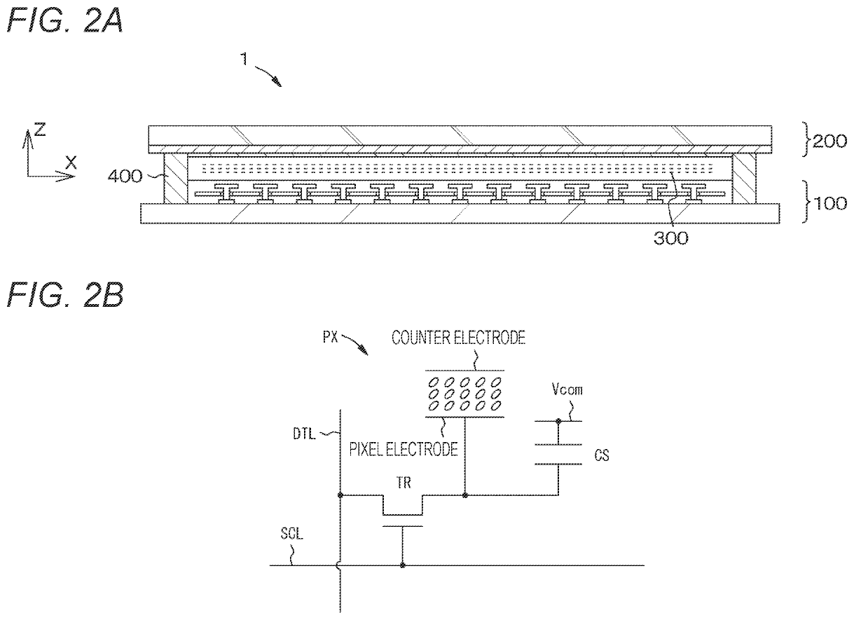

FIG. 2A is a schematic cross-sectional view for explaining a basic configuration of the liquid crystal display device. FIG. 2B is a schematic circuit diagram for explaining a pixel in the liquid crystal display device.

As illustrated in FIG. 2A, the liquid crystal display device 1 includes a pair of substrates consisting of a transistor array substrate 100 and a counter substrate 200 disposed so as to face the transistor array substrate 100. In addition, the liquid crystal display device 1 includes a liquid crystal material layer 300 sandwiched between the pair of substrates. The transistor array substrate 100 and the counter substrate 200 are sealed by a seal portion 400. The seal portion 400 has an annular shape surrounding the liquid crystal material layer 300.

As described later, the transistor array substrate 100 is formed by, for example, stacking various components on a support substrate including, for example, a glass material. The liquid crystal display device 1 is a transmissive liquid crystal display device.

The counter substrate 200 includes a counter electrode including a transparent conductive material such as ITO. More specifically, the counter substrate 200 includes a rectangular substrate including, for example, transparent glass, a counter electrode disposed on a surface of the substrate on the liquid crystal material layer 300 side, an alignment film disposed on the counter electrode, and the like. Furthermore, the transistor array substrate 100 and the counter substrate 200 appropriately each includes a polarizing plate, an alignment film, and the like. Note that, for convenience of illustration, the transistor array substrate 100 and the counter substrate 200 in FIG. 2A are illustrated in a simplified manner.

As illustrated in FIG. 2B, the liquid crystal cell constituting the pixel PX includes a pixel electrode disposed in the transistor array substrate 100, and a liquid crystal material layer or a counter electrode in a portion corresponding to the pixel electrode. In order to prevent deterioration of the liquid crystal material layer, a common potential V_{com} of positive polarity or negative polarity is alternately applied to the counter electrode when the liquid crystal display device 1 is driven. Note that elements of the pixel PX excluding the liquid crystal material layer and the counter electrode are formed in the transistor array substrate 100 illustrated in FIG. 2A.

As is clear from the line connection relationship in FIG. 2B, a pixel voltage supplied from the signal line DTL is applied to the pixel electrode via a transistor TR brought into a conductive state by a scanning signal of the scanning line SCL. Since the pixel electrode and one electrode of a capacitance structure CS are conductive to each other, the pixel voltage is also applied to the one electrode of the capacitance structure CS. Note that the common potential V_{com} is applied to the other electrode of the capacitance structure CS. In this configuration, even after the transistor TR is brought into a non-conductive state, the voltage of the pixel electrode is held by the capacitance of the liquid crystal cell and the capacitance structure CS.

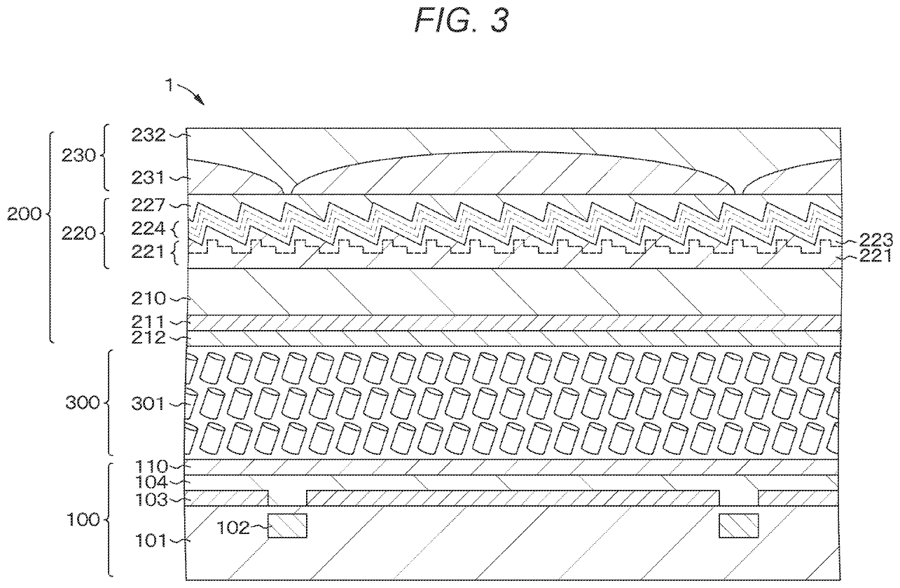

As described in detail with reference to FIGS. 3 to 6, the display device 1 according to the first embodiment includes an optical compensation element having an optical compensation film. The optical compensation element includes: a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

FIG. 3 is a schematic partial cross-sectional view for explaining the liquid crystal display device according to the present disclosure.

As described above, the liquid crystal display device 1 includes the transistor array substrate 100, the counter substrate 200, and the liquid crystal material layer 300 sandwiched between the transistor array substrate 100 and the counter substrate 200. A reference sign 301 schematically denotes a liquid crystal molecule.

The transistor array substrate 100 includes:

a support substrate 101 in which a transistor (not illustrated) and a wiring layer 102 constituting a black matrix are formed,

a pixel electrode 103 formed on the support substrate 101;

a planarization film 104 formed on the pixel electrode 103; and

an alignment film 110 formed on the planarization film 104.

The counter substrate 200 disposed so as to face the transistor array substrate 100 includes:

a substrate 210 including a transparent material;

a counter electrode (common electrode) 211 formed on one surface (surface on the liquid crystal material layer 300 side) of the substrate 210;

an alignment film 212 formed on the counter electrode 211;

an optical compensation element 220 disposed on the other surface of the substrate 210; and

a microlens layer 230 disposed on the optical compensation element 220 and including a microlens 231 and a filling layer 232.

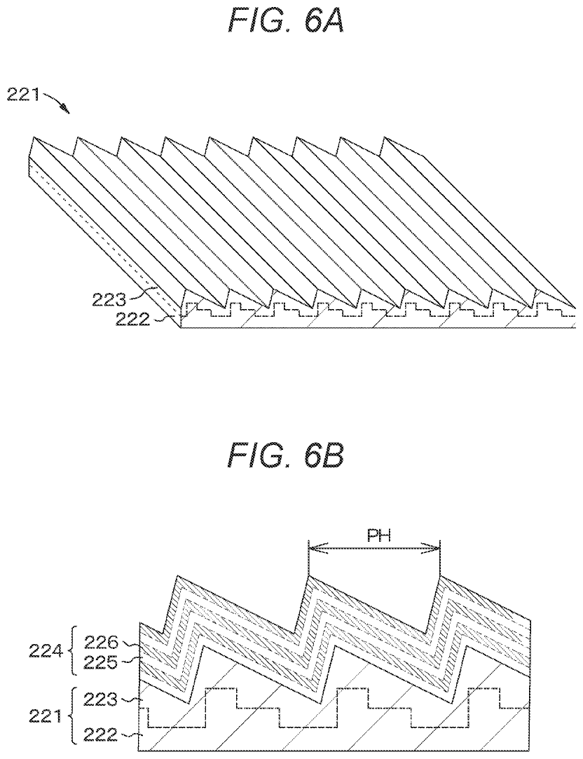

In the example illustrated in FIG. 3, the optical compensation element 220 is disposed in the counter substrate 200. The optical compensation element 220 includes: a base layer 221 having a serrated cross-sectional shape formed by repeatedly performing a film forming process and an etching process on a surface on which a set of a plurality of grooves having different depths is formed at a predetermined pitch; and an optical compensation film 224 in which a high refractive index film and a low refractive index film are alternately formed on the base layer 221. A reference sign 227 denotes a planarization film disposed on the optical compensation film 224. The optical compensation element 220 will be described later in detail with reference to FIG. 6 described later.

Note that a polarizing film (not illustrated) is disposed in each of the transistor array substrate 100 and the counter substrate 200 so as to have a cross Nicol or parallel Nicol relationship according to the specifications of the liquid crystal display device 1.

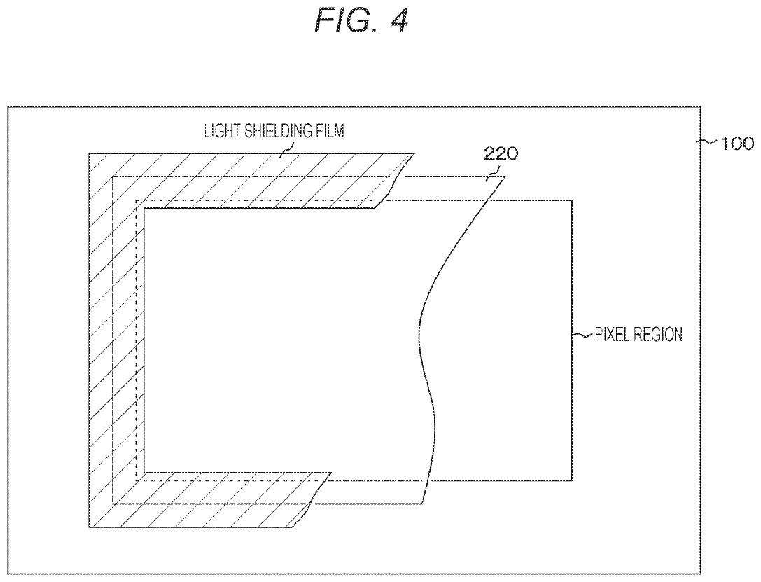

FIG. 4 is a schematic plan view for explaining a relationship among a region where a pixel is formed, a region where an optical compensation element is formed, and a region where a light shielding film is formed in the liquid crystal display device according to the present disclosure. Note that, for convenience of illustration, a part of the light shielding portion and a part of the optical compensation element are illustrated by being cut out.

As illustrated in FIG. 4, a region where the optical compensation element 220 is formed is set so as to include a pixel region. Furthermore, an effective display region is defined by the light shielding film covering a periphery of the pixel region. For example, light leakage slightly occurs at a region end portion of the optical compensation element 220. Therefore, the region end portion of the optical compensation element 220 is set so as to be positioned outside the pixel region.

Basically, the liquid crystal display device 1 can be manufactured using a known material or a known method. Note that a method for manufacturing the optical compensation element 220 will be described later.

As illustrated in FIG. 3, the liquid crystal material layer 300 is sandwiched between the transistor array substrate 100 and the counter substrate 200. An initial alignment direction of the liquid crystal molecules 301 of the liquid crystal material layer 300 is set by the alignment films 110 and 212. In a state where no electric field is applied to the liquid crystal material layer 300, the liquid crystal molecules 301 form a predetermined tilt angle and are aligned in a substantially vertical direction. The liquid crystal display device 1 is a so-called vertical alignment type (VA mode) liquid crystal display device.

Here, in order to help understanding of the present disclosure, optical compensation in the liquid crystal display device according to the first embodiment will be described.

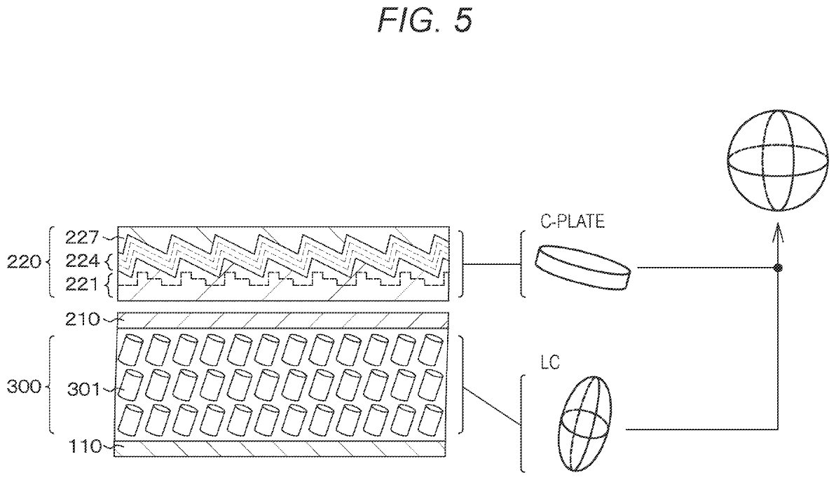

FIG. 5 is a schematic diagram for explaining optical compensation in the liquid crystal display device according to the first embodiment.

As illustrated on the left side of FIG. 5, the optical compensation film 224 formed on the base layer 221 having a serrated cross section exhibits, as a whole, a characteristic in a state where a C-plate is optically inclined. As a result, both refractive index anisotropy due to the tilt angle of the liquid crystal molecules 301 and refractive index anisotropy of the liquid crystal material layer 300 are compensated by the optical compensation element 220. As a result, the contrast of a displayed image can be increased.

FIG. 6A is a schematic perspective view for explaining a base layer having a serrated cross-sectional shape. FIG. 6B is a schematic partial cross-sectional view for explaining an optical compensation element including an optical compensation film formed on the base layer.

The base layer 221 illustrated in FIG. 6A is formed by repeatedly performing a film forming process and an etching process on a surface on which a set of a plurality of grooves having different depths is formed at a predetermined pitch. A reference sign 222 denotes an insulating material layer formed on the substrate 210 illustrated in FIG. 3, and a set of a plurality of grooves having different depths is formed at a predetermined pitch on a surface of the insulating material layer 222. A reference sign 223 denotes a portion formed by repeatedly performing a film forming process and an etching process on the surface of the insulating material layer 222.

Since a set of a plurality of grooves having different depths is formed at a predetermined pitch on the surface of the insulating material layer 222, by repeatedly performing a film forming process and an etching process thereon, a blazed structure having a serrated cross section is formed. An arrangement pitch thereof is a pitch of the set of grooves formed on the surface of the insulating material layer 222.

As illustrated in FIG. 6B, the optical compensation film 224 in which a high refractive index film 225 and a low refractive index film 226 are alternately formed is formed on the base layer 221. The high refractive index film 225 includes, for example, silicon nitride (SiNₓ), and the low refractive index film 226 includes, for example, silicon oxide (SiOₓ). The optical compensation film 224 has a serrated cross-section following the base layer 221. An arrangement pitch PH thereof is a pitch of the set of grooves formed on the surface of the insulating material layer 222. The pitch PH is preferably shorter than the wavelength of visible light. For example, the pitch PH is desirably 300 nanometers or less.

Next, a method for manufacturing the optical compensation element 220 will be described.

The method for manufacturing the optical compensation element 220 includes:

a step of forming a set of a plurality of grooves having different depths on a surface of a base body at a predetermined pitch;

a step of, subsequently, repeatedly performing a film forming process and an etching process on the surface to form a base layer having a serrated cross-sectional shape; and

a step of alternately forming a high refractive index film and a low refractive index film on the base layer to form an optical compensation film.

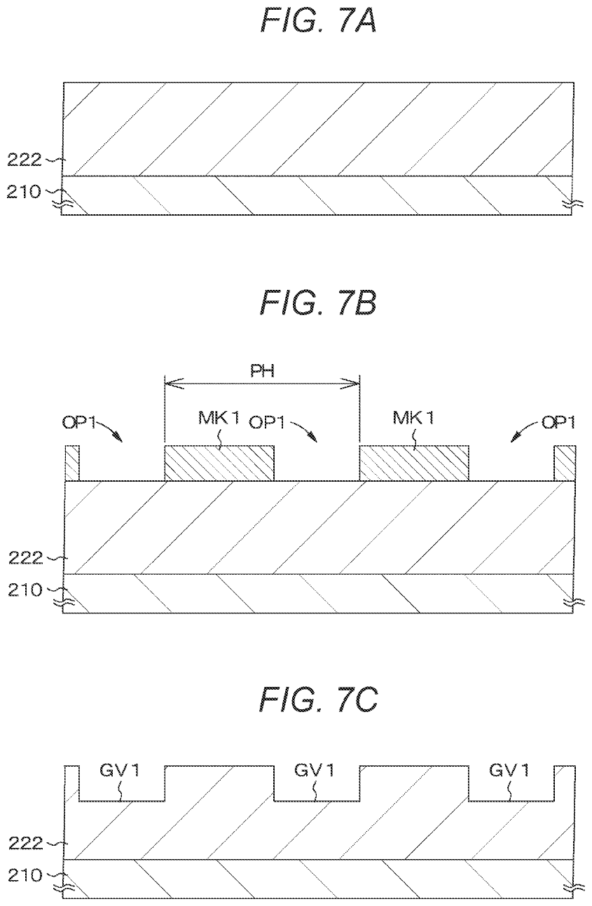

FIGS. 7 to 11 are schematic partial cross-sectional views for explaining the method for manufacturing the optical compensation element 220. Hereinafter, the method for manufacturing the optical compensation element 220 will be described in detail with reference to these drawings.

### [Step-100] (See FIG. 7A)

First, the insulating material layer 222 serving as a base body of the base layer 221 is formed on the substrate 210. Specifically, the substrate 210 is prepared, and the insulating material layer 222 including, for example, silicon oxide is formed thereon by a known film forming method.

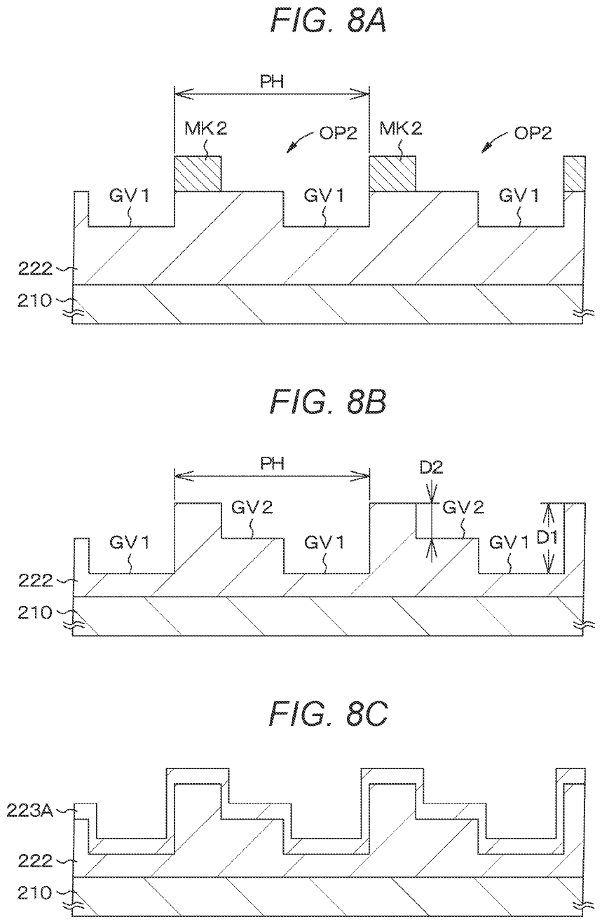

### [Step-110] (See FIGS. 7B, 7C, 8A, and 8B)

Thereafter, a set of a plurality of grooves having different depths is formed at a predetermined pitch on a surface of the insulating material layer 222 serving as a base body.

First, a linear mask MK1 is formed on the surface of the insulating material layer 222 at a predetermined pitch PH (see FIG. 7B). A reference sign OP1 denotes an opening between the masks MK1. Subsequently, the insulating material layer 222 exposed to the opening OP1 is removed to a predetermined depth by, for example, a dry etching method to form a first groove GV1, and then the mask MK1 is removed (see FIG. 7C).

Thereafter, a linear mask MK2 is formed on the surface of the insulating material layer 222 at a predetermined pitch PH. Note that the linear mask MK2 is formed so as to cover a part of a portion where the first groove GV1 is not formed (see FIG. 8A). A reference sign OP2 denotes an opening between the masks MK2. Subsequently, the insulating material layer 222 in the portion of the opening OP2 is removed to a predetermined depth by, for example, a dry etching method to form a second groove GV2, and then the mask MK2 is removed (see FIG. 8B). By this etching, the portion of the first groove GV1 is further etched. Therefore, when the depth of the first groove GV1 is denoted by a reference sign D1 and the depth of the second groove GV2 is denoted by a reference sign D2, D1>D2 is satisfied.

### [Step-120] (See FIGS. 8C, 9A, 9B, 9C, 10A, 10B, 10C, and 11A)

Subsequently, a film forming process and an etching process are repeatedly performed on the surface to form a base layer having a serrated cross-sectional shape. Here, a silicon oxide film is formed as the film forming process, and dry etching is performed as the etching process, but the present disclosure is not limited thereto. For example, the film forming process and the etching process can also be performed by performing high density plasma CVD on the surface.

First, a material layer 223A is formed on the surface of the insulating material layer 222 (see FIG. 8C). Note that the etching process is not performed here in order to protect the shape of the base body.

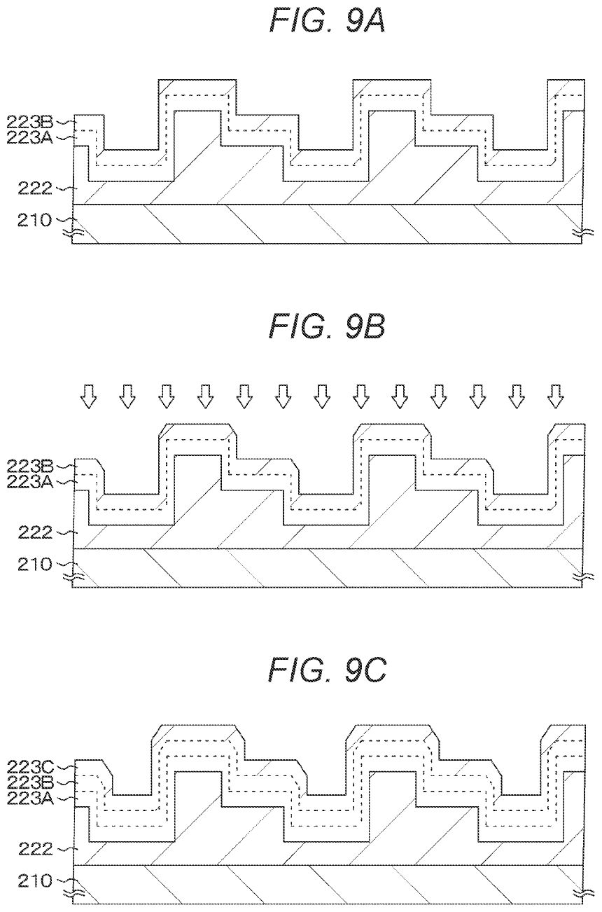

Subsequently, a material layer 223B is formed on the material layer 223A (see FIG. 9A). Thereafter, the etching process is performed on the entire surface. At this time, since etching of a corner portion proceeds more remarkably, the corner portion of the material layer 223B is further scraped (see FIG. 9B).

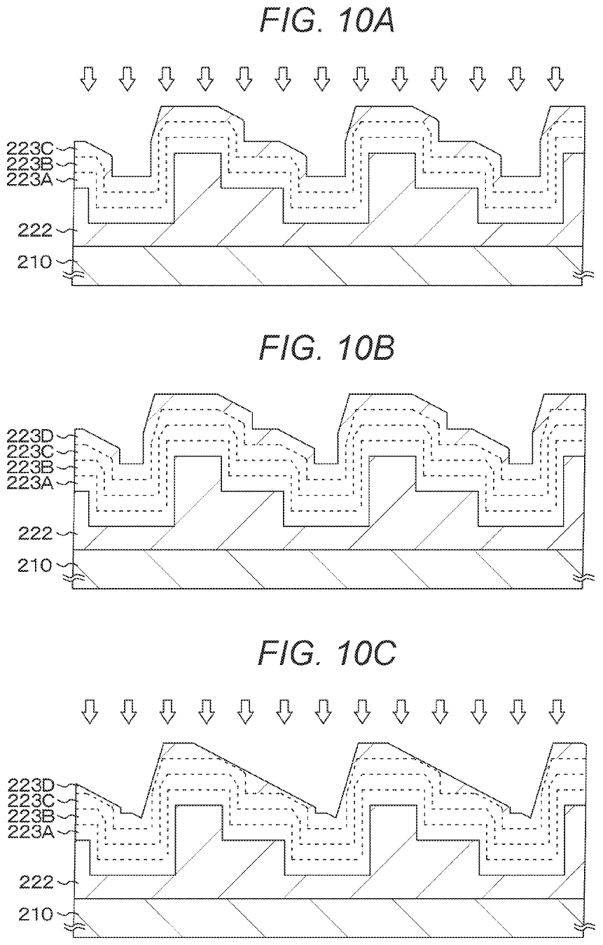

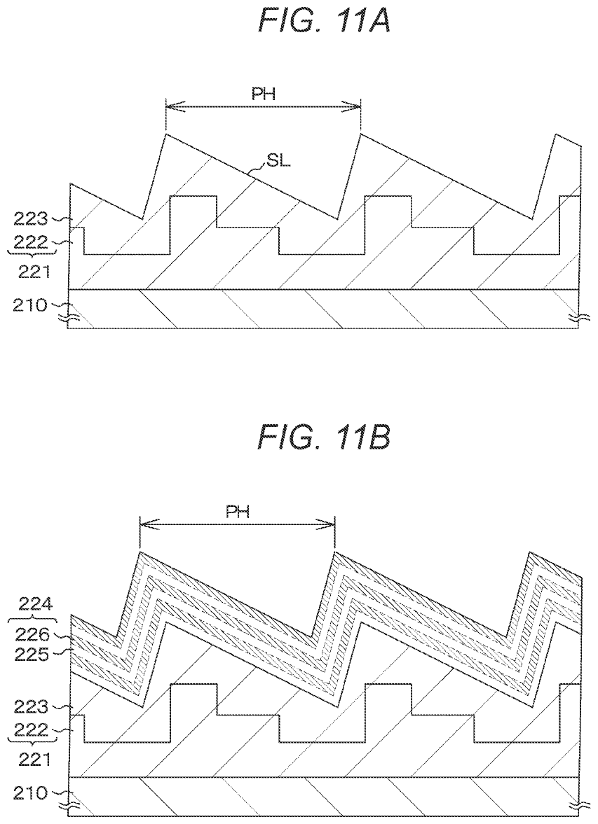

Subsequently, a material layer 223C is formed on the material layer 223B (see FIG. 9C). Thereafter, the etching process is performed on the entire surface (see FIG. 10A). Subsequently, a material layer 223D is formed on the material layer 223C (see FIG. 10B). Thereafter, the etching process is performed on the entire surface (see FIG. 10C). The cross-sectional shape of the stacked material layer 223 gradually approaches a serrated shape. Thereafter, by similarly repeating film formation and etching, the base layer 221 can be obtained (see FIG. 11A). A reference sign SL denotes an inclined surface of the base layer 221.

### [Step-130] (See FIG. 11B)

Subsequently, the optical compensation film 224 in which the high refractive index film 225 and the low refractive index film 226 are alternately formed is formed on the base layer 221. The optical compensation film 224 can be formed by, for example, a known film forming method such as a CVD method or a PVD method.

Hitherto, the method for manufacturing the optical compensation element 220 has been described.

As described above, the optical compensation element 220 has an advantage that the inclined surface can be formed at a fine pitch and is excellent also in terms of machine tact.

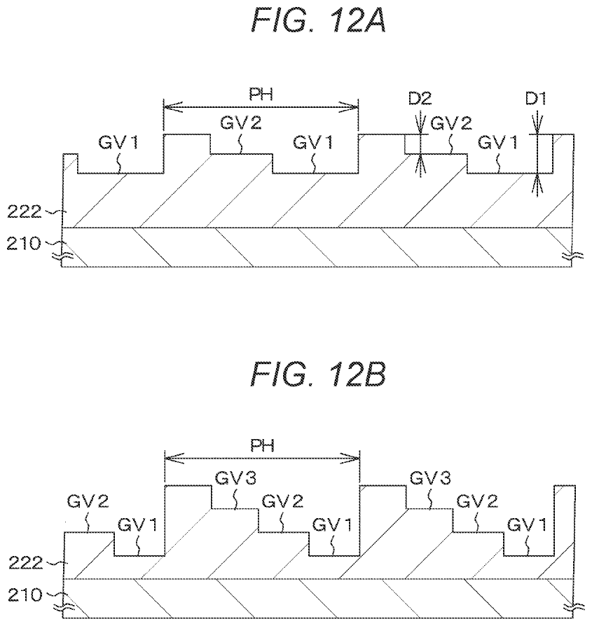

The pitch of the base layer 221 can be adjusted by setting the pitch PH of the set of the plurality of grooves having different depths on the surface of the base body 222. Furthermore, the inclination of the inclined surface of the base layer 221 can be adjusted by changing the depth of the groove formed in the surface of the base body 222. FIG. 12A is a modification in which the depth of the groove formed on the surface of the base body 222 is made shallow. Alternatively, the inclination of the inclined surface SL of the base layer 221 can be adjusted by adjusting a magnitude relationship between a film formation amount and an etching amount of each layer of the material layer 223.

Furthermore, in the example described above, the set of two grooves having different depths is formed on the surface of the base body, but this is merely an example. For example, as illustrated in FIG. 12B, a set of three grooves having different depths may be formed.

The counter substrate 200 illustrated in FIG. 3 can be obtained by forming the planarization film 227 on the optical compensation film 224, then forming the microlens layer 230, and further forming the counter electrode 211 and the alignment film 212 on a back surface side of the substrate 210. Furthermore, by sealing the transistor array substrate 100 and the counter substrate 200 with the liquid crystal material layer 300 sandwiched therebetween, the liquid crystal display device 1 can be obtained.

As described above, the optical compensation element 220 exhibits a characteristic in a state where the C-plate is optically inclined. As a result, the contrast of a displayed image can be increased. Furthermore, since all the optical compensation elements can be disposed in the liquid crystal display device, a highly reliable liquid crystal display device can be obtained.

Furthermore, in the example illustrated in FIG. 3, the optical compensation element 220 is disposed in the counter substrate 200, but can also be disposed on the transistor array substrate 100 side. For example, it is only required to dispose the optical compensation element 220 between the planarization film 104 and the alignment film 110 illustrated in FIG. 3.

Alternatively, a microlens is formed on a transparent substrate, and then a planarization layer is formed. Thereafter, a blazed structure having a serrated cross section is formed. Subsequently, an optical compensation film in which a high refractive index film and a low refractive index film are alternately formed is formed thereon. A step of further performing planarization and forming a TFT or the like thereon may be performed.

The first embodiment can be variously modified. Hereinafter, one modification will be described. In the modification described below, a part of a base layer is periodically removed such that an arrangement pitch of the base layer is shorter than an arrangement pitch of a set of a plurality of grooves having different depths.

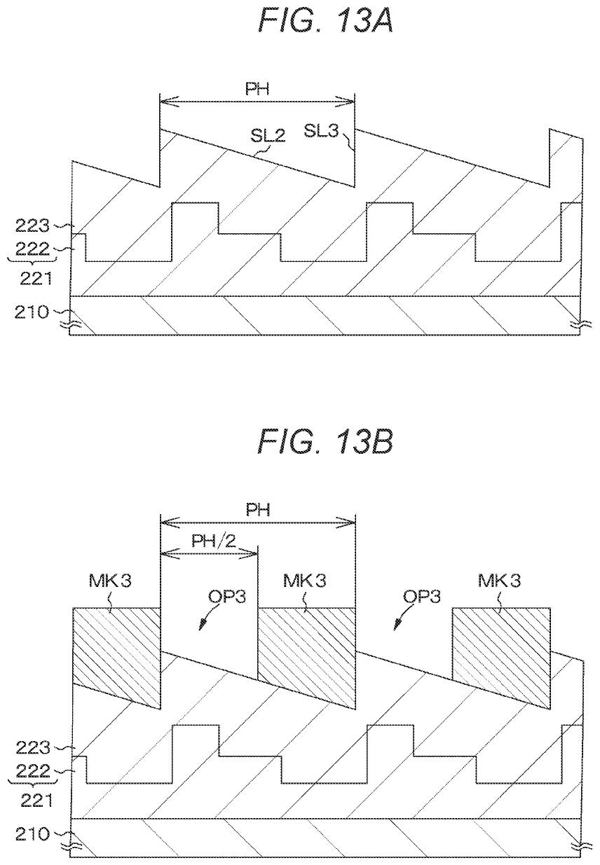

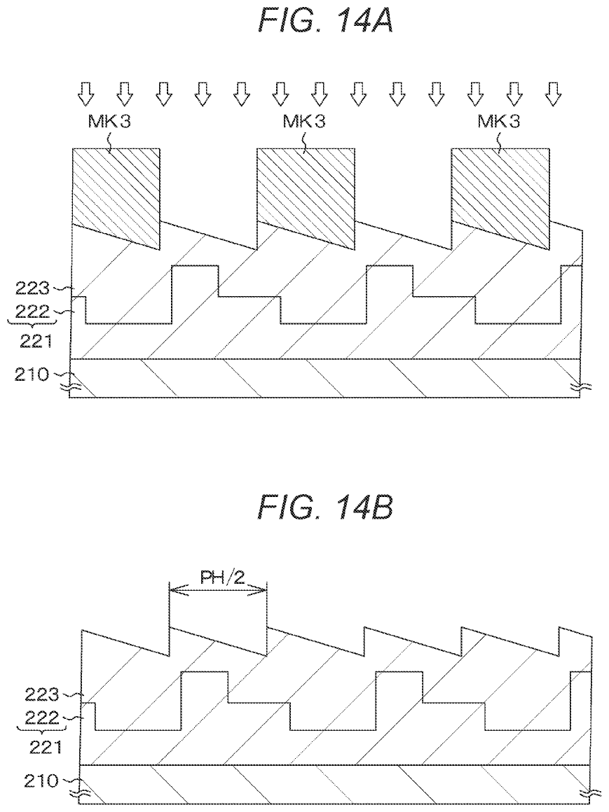

FIGS. 13 and 14 are schematic partial cross-sectional views for explaining a method for manufacturing an optical compensation element of the modification.

Hereinafter, the method for manufacturing the optical compensation element of the modification will be described. A method for manufacturing a base layer in the modification further includes a step of periodically removing a part of the base layer such that an arrangement pitch of the base layer is shorter than an arrangement pitch of a set of a plurality of grooves having different depths.

### [Step-100A] (See FIG. 13A)

By performing [step-100] to [step-120] described above, the material layer 223 having a serrated cross section is formed on the insulating material layer 222 serving as a base body to obtain the base layer 221. A reference sign SL2 denotes an inclined surface. Note that a surface SL3 illustrated in FIG. 13A is made as close to the vertical plane as possible.

### [Step-110A] (See FIGS. 13B, 14A, and 14B)

Thereafter, a part of the base layer 221 is periodically removed such that an arrangement pitch of the base layer is short. First, a linear mask MK3 is formed on the material layer 223 at a predetermined pitch PH (see FIG. 13B). A reference sign OP1 denotes an opening between the masks MK1. The opening OP and the mask MK3 each have a width of PH/2. The mask MK1 is formed so as to cover an inclined surface on the surface SL3 side.

Subsequently, the entire surface is etched (see FIG. 14A). By this etching, the material layer 223 in the portion of the opening OP3 is partially removed to make the inclined surface further dug. Subsequently, the mask MK1 is removed (see FIG. 14B). As a result, an arrangement pitch of the blazed structure having a serrated cross section is PH/2, which is a half of the pitch of the set of grooves formed on the surface of the base body 222.

### [Step-120A]

Subsequently, by performing a similar step to [step-130] described above, the optical compensation element of the modification can be obtained.

Hitherto, the method for manufacturing the optical compensation element of the modification has been described.

Note that, in the above-described example, the arrangement pitch of the blazed structure having a serrated cross section is PH/2, but the arrangement pitch can be PH/3, PH/4, or the like by forming a mask a plurality of times and performing etching.

As described above with reference to the various embodiments, the optical compensation element of the present disclosure has an advantage that the inclined surface can be formed at a fine pitch and is excellent also in terms of machine tact. Furthermore, the optical compensation element of the present disclosure has a configuration suitable for being formed in a substrate used in a liquid crystal display device.

The optical compensation element of the present disclosure described above can also be used as, for example, an optical compensation element disposed on a light condensing surface of a solid-state imaging element. By further disposing an optical reflection layer under the optical compensation film, the optical compensation element of the present disclosure can also be used as a reflective optical compensation element. Furthermore, the base layer 221 can also be used as a stamper for nanoimprinting.

### [Description of Electronic Apparatus]

The liquid crystal display device of the present disclosure described above can be used as a display section (display device) of an electronic apparatus in any field that displays a video signal input to an electronic apparatus or a video signal generated in the electronic apparatus as an image or a video. As an example, the liquid crystal display device of the present disclosure can be used as a display section of, for example, a television set, a digital still camera, a notebook personal computer, a mobile terminal device such as a mobile phone, a video camera, or a head mounted display.

The liquid crystal display device of the present disclosure also includes a liquid crystal display device having a module shape with a sealed configuration. Note that the display module may include a circuit section for inputting and outputting a signal and the like from the outside to a pixel array section, a flexible printed circuit (FPC), and the like. Hereinafter, as specific examples of the electronic apparatus using the liquid crystal display device of the present disclosure, a projection type display device, a digital still camera, and a head mounted display will be exemplified. However, the specific examples exemplified here are merely examples, and the present disclosure is not limited thereto.

### Specific Example 1

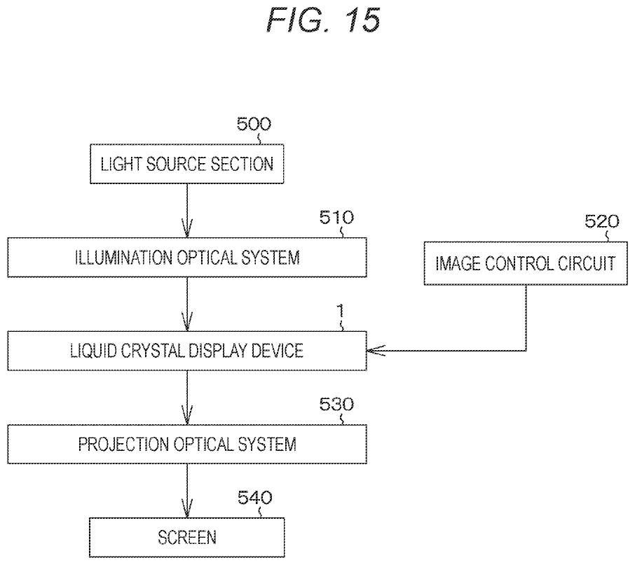

FIG. 15 is a conceptual diagram of a projection type display device using the liquid crystal display device of the present disclosure. The projection type display device includes a light source section 500, an illumination optical system 510, the liquid crystal display device 1, an image control circuit 520 that drives the liquid crystal display device, a projection optical system 530, a screen 540, and the like. The light source section 500 can include, for example, various lamps such as a xenon lamp, and a semiconductor light emitting element such as a light emitting diode. The illumination optical system 510 is used to guide light from the light source section 500 to the liquid crystal display device 1, and includes an optical element such as a prism or a dichroic mirror. The liquid crystal display device 1 acts as a light valve, and an image is projected on the screen 540 through the projection optical system 530.

### Specific Example 2

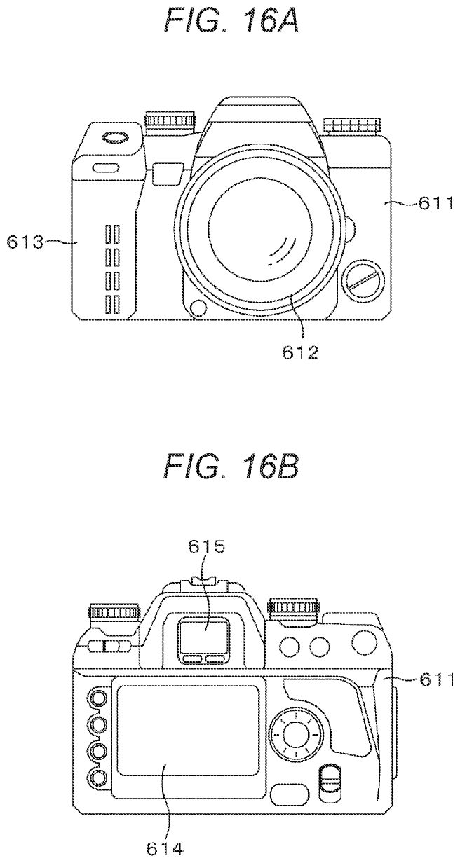

FIG. 16 is an external view of a lens interchangeable single-lens reflex type digital still camera, in which FIG. 16A illustrates a front view thereof, and FIG. 16B illustrates a rear view thereof. This lens interchangeable single-lens reflex type digital still camera has, for example, an interchangeable imaging lens unit (interchangeable lens) 612 on a front right side of a camera body 611, and has a grip portion 613 to be gripped by an imaging person on a front left side thereof.

In addition, a monitor 614 is disposed at substantially the center of a rear surface of the camera body 611. A viewfinder (eyepiece window) 615 is disposed above the monitor 614. By looking through the viewfinder 615, an imaging person can visually recognize a light image of a subject guided from the imaging lens unit 612 and determine a composition.

In the lens interchangeable single-lens reflex type digital still camera having the above configuration, the display device of the present disclosure can be used as the viewfinder 615 thereof. That is, the lens interchangeable single-lens reflex type digital still camera according to the present example is manufactured by using the display device of the present disclosure as the viewfinder 615 thereof.

### Specific Example 3

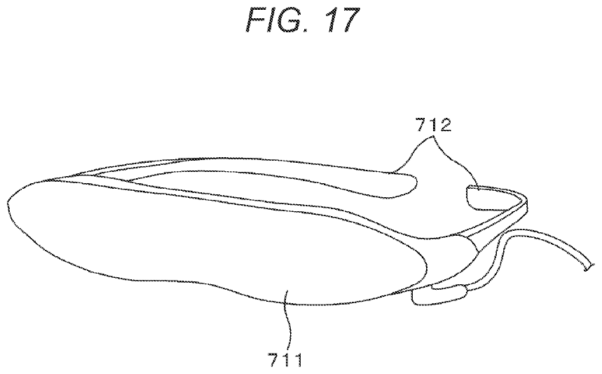

FIG. 17 is an external view of a head mounted display. The head mounted display includes, for example, ear hooking portions 712 to be mounted on the head of a user on both sides of an eyeglass-shaped display section 711. In this head mounted display, the liquid crystal display device of the present disclosure can be used as the display section 711 thereof. That is, the head mounted display according to the present example is manufactured by using the liquid crystal display device of the present disclosure as the display section 711 thereof.

### Specific Example 4

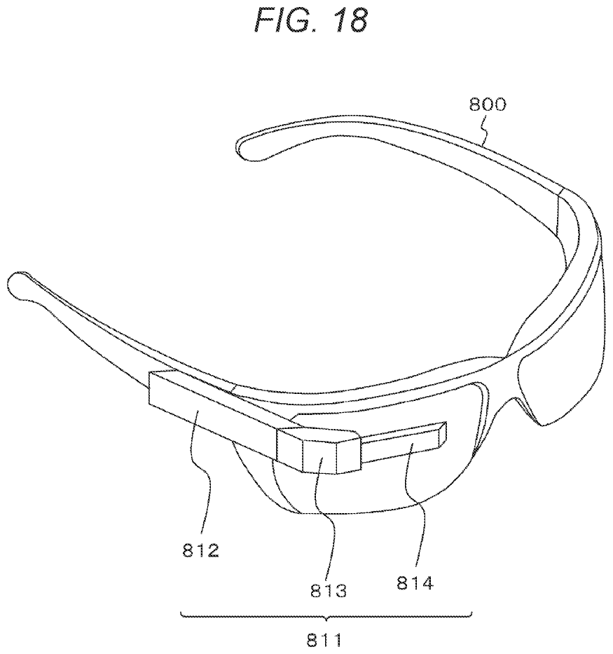

FIG. 18 is an external view of a see-through head mounted display. A see-through head mounted display 811 includes a main body 812, an arm 813, and a lens barrel 814.

The main body 812 is connected to the arm 813 and eyeglasses 800. Specifically, an end portion of the main body 812 in a long side direction is coupled to the arm 813, and one side of a side surface of the main body 812 is linked to the eyeglasses 800 via a connecting member. Note that the main body 812 may be directly mounted on the head of a human body.

The main body 812 has a control substrate for controlling action of the see-through head mounted display 811 and a display section built-in. The arm 813 connects the main body 812 and the lens barrel 814 to each other and supports the lens barrel 814. Specifically, the arm 813 is coupled to an end of the main body 812 and an end of the lens barrel 814 to fix the lens barrel 814. Furthermore, the arm 813 has a signal line for communicating data related to an image provided from the main body 812 to the lens barrel 814 built-in.

The lens barrel 814 projects image light provided from the main body 812 via the arm 813 toward the eyes of a user wearing the see-through head mounted display 811 through an eyepiece. In this see-through head mounted display 811, the display device of the present disclosure can be used as the display section of the main body 812.

### Application Example

The technology according to the present disclosure can be applied to various products. For example, the technology according to the present disclosure may be implemented as a device mounted on any type of mobile body such as an automobile, an electric vehicle, a hybrid electric vehicle, a motorcycle, a bicycle, a personal mobility, an airplane, a drone, a ship, a robot, a construction machine, or an agricultural machine (tractor).

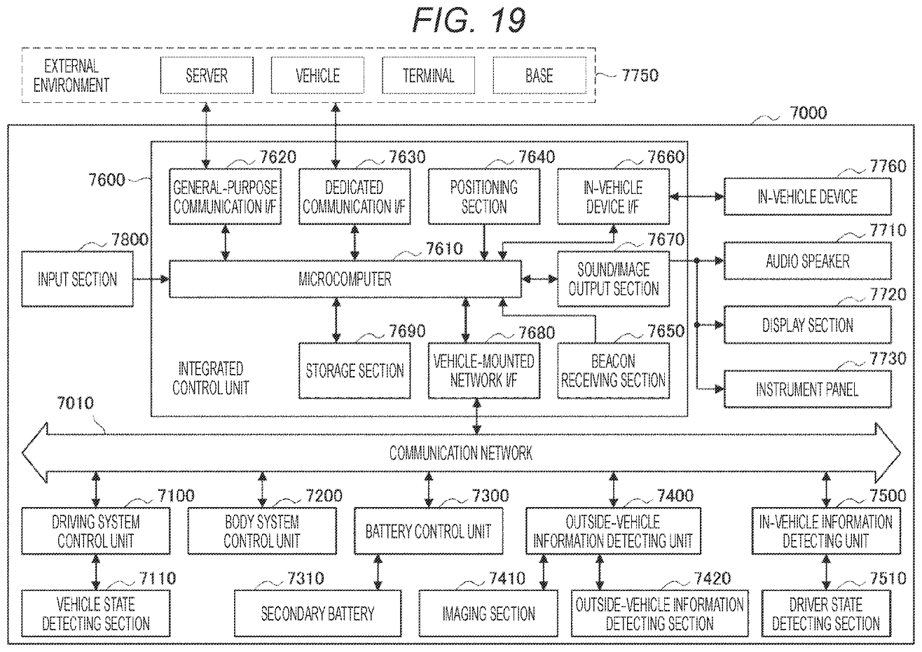

FIG. 19 is a block diagram illustrating an example of a schematic configuration of a vehicle control system 7000 which is an example of a mobile body control system to which the technology according to the present disclosure can be applied. The vehicle control system 7000 includes a plurality of electronic control units connected to each other via a communication network 7010. In the example illustrated in FIG. 19, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may be, for example, a vehicle-mounted communication network compliant with an arbitrary standard, such as controller area network (CAN), local interconnect network (LIN), local area network (LAN), or FlexRay (registered trademark).

Each of the control units includes: a microcomputer that performs arithmetic processing in accordance with various programs; a storage section that stores a program executed by the microcomputer, parameters used for various operations, and the like; and a driving circuit that drives various control target devices. Each of the control units further includes: a network interface (I/F) for performing communication with other control units via the communication network 7010; and a communication I/F for performing communication with an in-vehicle or outside-vehicle device, an in-vehicle or outside-vehicle sensor, or the like by wired communication or wireless communication. A functional configuration of the integrated control unit 7600 illustrated in FIG. 19 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly each include a microcomputer, a communication I/F, a storage section, and the like.

The driving system control unit 7100 controls action of a device related to a driving system of the vehicle in accordance with various programs. For example, the driving system control unit 7100 functions as a control device of a driving force generating device for generating a driving force of the vehicle, such as an internal combustion engine or a driving motor, a driving force transmitting mechanism for transmitting a driving force to wheels, a steering mechanism for adjusting a steering angle of the vehicle, a braking device for generating a braking force of the vehicle, or the like. The driving system control unit 7100 may have a function as a control device of an antilock brake system (ABS), electronic stability control (ESC), or the like.

To the driving system control unit 7100, a vehicle state detecting section 7110 is connected. The vehicle state detecting section 7110 includes, for example, at least one of a gyro sensor that detects an angular velocity of axial rotational movement of a vehicle body, an acceleration sensor that detects an acceleration of the vehicle, and sensors for detecting the amount of operation of an accelerator pedal, the amount of operation of a brake pedal, a steering angle of a steering wheel, an engine speed, a rotational speed of wheels, and the like. The driving system control unit 7100 performs arithmetic processing using a signal input from the vehicle state detecting section 7110, and controls an internal combustion engine, a driving motor, an electric power steering device, a brake device, and the like.

The body system control unit 7200 controls action of various devices mounted on the vehicle body in accordance with various programs. For example, the body system control unit 7200 functions as a control device of a keyless entry system, a smart key system, a power window device, or various lamps such as a headlamp, a back lamp, a brake lamp, a turn signal, and a fog lamp. In this case, radio waves transmitted from a mobile device as an alternative to a key or signals of various switches can be input to the body system control unit 7200. The body system control unit 7200 receives these input radio waves or signals, and controls a door lock device, a power window device, lamps, and the like of the vehicle.

The battery control unit 7300 controls a secondary battery 7310, which is a power supply source for a driving motor, in accordance with various programs. For example, to the battery control unit 7300, information such as a battery temperature, a battery output voltage, or the amount of capacity remaining in a battery is input from a battery device including the secondary battery 7310. The battery control unit 7300 performs arithmetic processing using these signals, and performs control for regulating the temperature of the secondary battery 7310 or controls a cooling device included in the battery device or the like.

The outside-vehicle information detecting unit 7400 detects information regarding the outside of the vehicle including the vehicle control system 7000. For example, to the outside-vehicle information detecting unit 7400, at least one of an imaging section 7410 or an outside-vehicle information detecting section 7420 is connected. The imaging section 7410 includes at least one of a time of flight (ToF) camera, a stereo camera, a monocular camera, an infrared camera, and other cameras. The outside-vehicle information detecting section 7420 includes, for example, at least one of an environmental sensor for detecting current atmospheric conditions or weather conditions and a peripheral information detecting sensor for detecting another vehicle, an obstacle, a pedestrian, or the like around the vehicle including the vehicle control system 7000.

The environmental sensor may be, for example, at least one of a rain drop sensor that detects rain, a fog sensor that detects fog, a sunshine sensor that detects a degree of sunshine, and a snow sensor that detects snowfall. The peripheral information detecting sensor may be at least one of an ultrasonic sensor, a radar device, and a light detection and ranging or laser imaging detection and ranging (LIDAR) device. Each of the imaging section 7410 and the outside-vehicle information detecting section 7420 may be disposed as an independent sensor or device, or may be disposed as a device in which a plurality of sensors or devices is integrated.

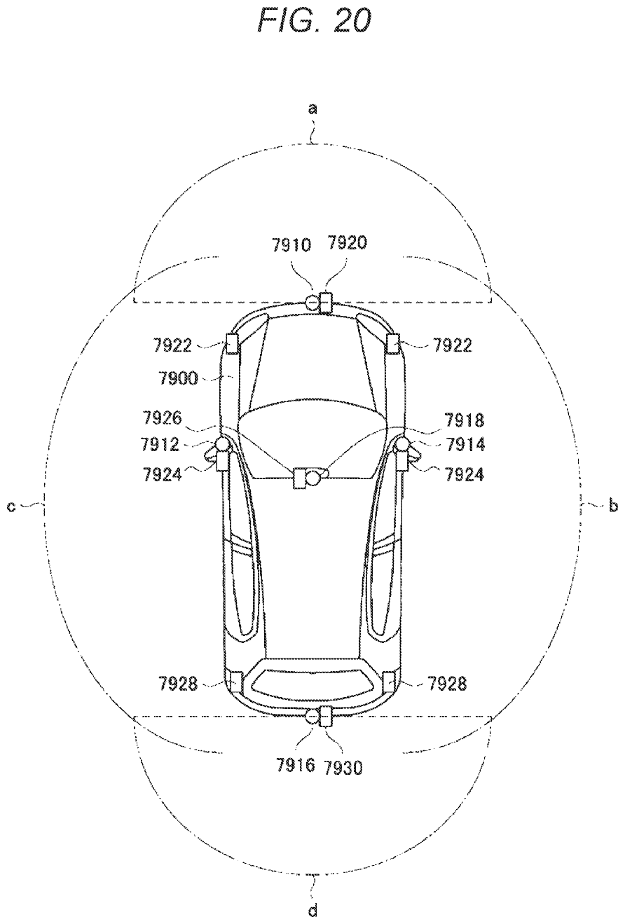

Here, FIG. 20 illustrates an example of positions where the imaging section 7410 and the outside-vehicle information detecting section 7420 are disposed. Imaging sections 7910, 7912, 7914, 7916, and 7918 are disposed at, for example, at least one position of a front nose of a vehicle 7900, a sideview mirror thereof, a rear bumper thereof, a back door thereof, and an upper portion of a windshield in a vehicle interior thereof. The imaging section 7910 disposed in the front nose and the imaging section 7918 disposed in the upper portion of the windshield in a vehicle interior acquire mainly an image of the front of the vehicle 7900. The imaging sections 7912 and 7914 disposed in the sideview mirrors acquire mainly an image of the sides of the vehicle 7900. The imaging section 7916 disposed in the rear bumper or the back door acquires mainly an image of the rear of the vehicle 7900. The imaging section 7918 disposed in the upper portion of the windshield in a vehicle interior is used mainly to detect a preceding vehicle, a pedestrian, an obstacle, a signal, a traffic sign, a lane, or the like.

Note that FIG. 20 illustrates an example of imaging ranges of the imaging sections 7910, 7912, 7914, and 7916. An imaging range a indicates an imaging range of the imaging section 7910 disposed in the front nose. Imaging ranges b and c indicate imaging ranges of the imaging sections 7912 and 7914 disposed in the sideview mirrors, respectively. An imaging range d indicates an imaging range of the imaging section 7916 disposed in the rear bumper or the back door. For example, by superimposing image data imaged by the imaging sections 7910, 7912, 7914, and 7916, a bird's-eye image of the vehicle 7900 as viewed from above can be obtained.

Outside-vehicle information detecting sections 7920, 7922, 7924, 7926, 7928, and 7930 disposed in the front of the vehicle 7900, the rear thereof, the sides thereof, the corners thereof, and the upper portion of the windshield in a vehicle interior thereof may be each, for example, an ultrasonic sensor or a radar device. The outside-vehicle information detecting sections 7920, 7926, and 7930 disposed in the front nose of the vehicle 7900, the rear bumper thereof, the back door thereof, and the upper portion of the windshield in a vehicle interior thereof may be each, for example, a LIDAR device. These outside-vehicle information detecting sections 7920 to 7930 are used mainly to detect a preceding vehicle, a pedestrian, an obstacle, or the like.

Returning to FIG. 19, the description will be continued. The outside-vehicle information detecting unit 7400 causes the imaging section 7410 to image an image of the outside of the vehicle, and receives imaged image data. Furthermore, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information regarding a received reflected wave. On the basis of the received information, the outside-vehicle information detecting unit 7400 may perform a process of detecting an object such as a human, a vehicle, an obstacle, a sign, a character on a road surface, or the like, or a process of detecting a distance thereto. The outside-vehicle information detecting unit 7400 may perform an environment recognition process of recognizing rainfall, fog, road surface conditions, or the like on the basis of the received information. The outside-vehicle information detecting unit 7400 may calculate a distance to an object outside the vehicle on the basis of the received information.

Furthermore, on the basis of the received image data, the outside-vehicle information detecting unit 7400 may perform an image recognition process of recognizing a human, a vehicle, an obstacle, a sign, a character on a road surface, or the like, or a process of detecting a distance thereto. The outside-vehicle information detecting unit 7400 may perform a process such as distortion correction or alignment on the received image data, and combine the image data imaged by the different imaging sections 7410 to generate a bird's-eye image or a panoramic image. The outside-vehicle information detecting unit 7400 may perform a viewpoint conversion process using the image data imaged by the different imaging sections 7410.

The in-vehicle information detecting unit 7500 detects in-vehicle information. To the in-vehicle information detecting unit 7500, for example, a driver state detecting section 7510 that detects the state of a driver is connected. The driver state detecting section 7510 may include a camera that images a driver, a biosensor that detects biological information of the driver, a microphone that collects sound in a vehicle interior, or the like. The biosensor is, for example, disposed on a seat surface, a steering wheel, or the like, and detects biological information of an occupant sitting on the seat or a driver holding the steering wheel. On the basis of detection information input from the driver state detecting section 7510, the in-vehicle information detecting unit 7500 may calculate a degree of fatigue of a driver or a degree of concentration of the driver, or may determine whether or not the driver is dozing. The in-vehicle information detecting unit 7500 may perform a process such as a noise canceling process on a sound signal obtained by collection of sound.

The integrated control unit 7600 controls general action in the vehicle control system 7000 in accordance with various programs. To the integrated control unit 7600, an input section 7800 is connected. The input section 7800 is implemented, for example, by a device capable of being input-operated by an occupant, such as a touch panel, a button, a microphone, a switch, or a lever. To the integrated control unit 7600, data obtained by sound recognition of sound input through a microphone may be input. The input section 7800 may be, for example, a remote control device using an infrared ray or another radio wave, or an external connecting device such as a mobile telephone or a personal digital assistant (PDA) corresponding to operation of the vehicle control system 7000. The input section 7800 may be, for example, a camera. In this case, an occupant can input information by gesture. Alternatively, data obtained by detecting movement of a wearable device worn by an occupant may be input. Moreover, the input section 7800 may include, for example, an input control circuit that generates an input signal on the basis of information input by an occupant or the like using the above-described input section 7800, and outputs the generated input signal to the integrated control unit 7600. An occupant or the like inputs various kinds of data or gives an instruction for processing action to the vehicle control system 7000 by operating the input section 7800.

The storage section 7690 may include a read only memory (ROM) that stores various programs executed by the microcomputer and a random access memory (RAM) that stores various parameters, operation results, sensor values, and the like. Furthermore, the storage section 7690 may be implemented by a magnetic storage device such as a hard disc drive (HDD), a semiconductor storage device, an optical storage device, a magneto-optical storage device, or the like.

The general-purpose communication I/F 7620 is a general-purpose communication I/F that mediates communication with various apparatuses present in an external environment 7750. The general-purpose communication I/F 7620 may implement a cellular communication protocol such as global system of mobile communications (GSM (registered trademark)), WiMAX, long term evolution (LTE), or LTE-advanced (LTE-A), or another wireless communication protocol such as wireless LAN (also referred to as Wi-Fi (registered trademark)) or Bluetooth (registered trademark). The general-purpose communication I/F 7620 may be connected to, for example, an apparatus (for example, an application server or a control server) present on an external network (for example, the Internet, a cloud network, or a company-specific network) via a base station or an access point. Furthermore, the general-purpose communication I/F 7620 may be connected to a terminal present near the vehicle (for example, a terminal of a driver, a pedestrian, or a store, or a machine type communication (MTC) terminal) using, for example, peer to peer (P2P) technology.

The dedicated communication I/F 7630 is a communication I/F that supports a communication protocol developed for use in the vehicle. The dedicated communication I/F 7630 may implement, for example, a standard protocol such as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

For example, the positioning section 7640 performs positioning by receiving a global navigation satellite system (GNSS) signal from a GNSS satellite (for example, a global positioning system (GPS) signal from a GPS satellite), and generates positional information including the latitude, longitude, and altitude of the vehicle. Note that the positioning section 7640 may identify a current position by exchanging signals with a wireless access point, or may acquire positional information from a terminal such as a mobile telephone, a personal handyphone system (PHS), or a smart phone having a positioning function.

For example, the beacon receiving section 7650 receives a radio wave or an electromagnetic wave transmitted from a radio station or the like installed on a road, and acquires information regarding a current position, congestion, a closed road, a necessary time, or the like. Note that the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present in the vehicle. The in-vehicle device I/F 7660 may establish wireless connection using a wireless communication protocol such as wireless LAN, Bluetooth (registered trademark), near field communication (NFC), or wireless universal serial bus (WUSB). Furthermore, the in-vehicle device I/F 7660 may establish wired connection such as universal serial bus (USB), high-definition multimedia interface (HDMI (registered trademark)), or mobile high-definition link (MHL) via a connection terminal (and a cable if necessary) (not illustrated). The in-vehicle device 7760 may include, for example, at least one of a mobile device and a wearable device possessed by an occupant and an information device carried into or attached to the vehicle. Furthermore, the in-vehicle device 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals and the like in conformity with a predetermined protocol supported by the communication network 7010.

The microcomputer 7610 of the integrated control unit 7600 controls the vehicle control system 7000 in accordance with various programs on the basis of information acquired via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the acquired in-vehicle or outside-vehicle information, and output a control command to the driving system control unit 7100. For example, the microcomputer 7610 may perform cooperative control intended to implement a function of an advanced driver assistance system (ADAS) including collision avoidance or shock mitigation for the vehicle, following traveling based on a distance between vehicles, vehicle speed maintaining traveling, warning of collision of the vehicle, warning of deviation of the vehicle from a lane, or the like. Furthermore, the microcomputer 7610 may perform cooperative control intended for automated driving, which makes the vehicle to travel automatedly without depending on operation of a driver, or the like, by controlling the driving force generating device, the steering mechanism, the braking device, or the like on the basis of the acquired information regarding the surroundings of the vehicle.

The microcomputer 7610 may generate three-dimensional distance information between the vehicle and an object such as a surrounding structure, person, or the like, and generate local map information including information regarding the surroundings of the current position of the vehicle on the basis of information acquired via at least one of the general-purpose communication I/F 7620, the dedicated communication I/F 7630, the positioning section 7640, the beacon receiving section 7650, the in-vehicle device I/F 7660, and the vehicle-mounted network I/F 7680. Furthermore, the microcomputer 7610 may predict danger such as collision of the vehicle, approaching of a pedestrian or the like, an entry to a closed road, or the like on the basis of the acquired information, and generate a warning signal. The warning signal may be, for example, a signal for generating a warning sound or lighting a warning lamp.

The sound/image output section 7670 transmits an output signal of at least one of a sound or an image to an output device capable of visually or auditorily notifying an occupant of the vehicle or the outside of the vehicle of information. In the example of FIG. 19, as the output device, an audio speaker 7710, a display section 7720, and an instrument panel 7730 are illustrated. The display section 7720 may include, for example, at least one of an on-board display and a head-up display. The display section 7720 may have an augmented reality (AR) display function. The output device may be a device other than these devices, such as a headphone, a wearable device such as an eyeglass type display worn by an occupant, a projector, or a lamp. In a case where the output device is a display device, the display device visually displays results obtained by various processes performed by the microcomputer 7610 or information received from another control unit in various forms such as a text, an image, a table, and a graph. Furthermore, in a case where the output device is a sound output device, the sound output device converts an audio signal including reproduced sound data, reproduced acoustic data, or the like into an analog signal, and auditorily outputs the analog signal.

Note that at least two control units connected to each other via the communication network 7010 in the example illustrated in FIG. 19 may be integrated into one control unit. Alternatively, each individual control unit may include a plurality of control units. Moreover, the vehicle control system 7000 may include another control unit not illustrated. Furthermore, a part or the whole of the function performed by any one of the control units in the above description may be performed by another control unit. That is, predetermined arithmetic processing may be performed by any one of the control units as long as information is transmitted and received via the communication network 7010. Similarly, a sensor or a device connected to any one of the control units may be connected to another control unit, and a plurality of control units may mutually transmit and receive detection information via the communication network 7010.

The technology according to the present disclosure can be applied to, for example, a display section of an output device capable of visually or auditorily giving notification of information among the above-described configurations.

### [Others]

Note that the present disclosure can have the following configurations.

### [A1]

A liquid crystal display device including:

a pair of substrates;

a liquid crystal material layer sandwiched between the pair of substrates; and

an optical compensation element having an optical compensation film, in which

the optical compensation element includes: a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

### [A2]

The liquid crystal display device according to [A1], in which

each of the high refractive index film and the low refractive index film includes an inorganic insulating material.

### [A3]

The liquid crystal display device according to [A2], in which

each of the high refractive index film and the low refractive index film includes any one of silicon oxide, silicon nitride, and silicon oxynitride.

### [A4]

The liquid crystal display device according to any one of [A1] to [A3], in which

an arrangement pitch of the set of the plurality of grooves having different depths is 300 nanometers or less.

### [A5]

The liquid crystal display device according to any one of [A1] to [A4], in which

a part of the base layer is periodically removed such that an arrangement pitch of the base layer is shorter than an arrangement pitch of the set of the plurality of grooves having different depths.

### [A6]

The liquid crystal display device according to any one of [A1] to [A5], including

a transistor array substrate and a counter substrate that is disposed so as to face the transistor array substrate, as the pair of substrates.

### [A7]

The liquid crystal display device according to [A6], in which

the optical compensation element is disposed in at least one of the counter substrate or the transistor array substrate.

### [A8]

The liquid crystal display device according to [A6] or [A7], in which

a black matrix and/or a microlens are/is formed in at least one of the counter substrate or the transistor array substrate.

### [B1]

An optical compensation element including:

a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

### [B2]

The optical compensation element according to [B1], in which

each of the high refractive index film and the low refractive index film includes an inorganic insulating material.

### [B3]

The optical compensation element according to [B2], in which

each of the high refractive index film and the low refractive index film includes any one of silicon oxide, silicon nitride, and silicon oxynitride.

### [B4]

The optical compensation element according to any one of [B1] to [B3], in which

an arrangement pitch of the set of the plurality of grooves having different depths is 300 nanometers or less.

### [B5]

The optical compensation element according to any one of [B1] to [B4], in which

a part of the base layer is periodically removed such that an arrangement pitch of the base layer is shorter than an arrangement pitch of the set of the plurality of grooves having different depths.

### [C1]

A method for manufacturing an optical compensation element, including:

a step of forming a set of a plurality of grooves having different depths on a surface of a base body at a predetermined pitch;

a step of, subsequently, repeatedly performing a film forming process and an etching process on the surface to form a base layer having a serrated cross-sectional shape; and

a step of alternately forming a high refractive index film and a low refractive index film on the base layer to form an optical compensation film.

### [C2]

The method for manufacturing an optical compensation element according to [C1], in which

the step of repeatedly performing a film forming process and an etching process on the surface to form a base layer having a serrated cross-sectional shape is performed by performing high density plasma CVD on the surface.

### [C3]

The method for manufacturing an optical compensation element according to [C1] or [C2], further including

a step of periodically removing a part of the base layer such that an arrangement pitch of the base layer is shorter than an arrangement pitch of the set of the plurality of grooves having different depths.

### [D1]

An electronic apparatus including a liquid crystal display device including:

a pair of substrates;

a liquid crystal material layer sandwiched between the pair of substrates; and

an optical compensation element having an optical compensation film, in which

the optical compensation element includes: a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

### [D2]

The electronic apparatus according to [D1], in which

each of the high refractive index film and the low refractive index film includes an inorganic insulating material.

### [D3]

The electronic apparatus according to [D2], in which

each of the high refractive index film and the low refractive index film includes any one of silicon oxide, silicon nitride, and silicon oxynitride.

### [D4]

The electronic apparatus according to any one of [D1] to [D3], in which

an arrangement pitch of the set of the plurality of grooves having different depths is 300 nanometers or less.

### [D5]

The electronic apparatus according to any one of [D1] to [D4], in which

a part of the base layer is periodically removed such that an arrangement pitch of the base layer is shorter than an arrangement pitch of the set of the plurality of grooves having different depths.

### [D6]

The electronic apparatus according to any one of [D1] to [D5], including

a transistor array substrate and a counter substrate that is disposed so as to face the transistor array substrate, as the pair of substrates.

### [D7]

The electronic apparatus according to [D6], in which

the optical compensation element is disposed in at least one of the counter substrate or the transistor array substrate.

### [D8]

The electronic apparatus according to [D6] or [D7], in which

a black matrix and/or a microlens are/is formed in at least one of the counter substrate or the transistor array substrate.

### REFERENCE SIGNS LIST

1 Liquid crystal display device
11 Horizontal drive circuit
12 Vertical drive circuit
100 Transistor array substrate
101 Support substrate
102 Wiring layer
103 Pixel electrode
104 Planarization film
110 Alignment film
200 Counter substrate
210 Substrate
211 Counter electrode (common electrode)
212 Alignment film
220 Optical compensation element
221 Base layer
222 Insulating material layer (base body)
223 Material layer
224 Optical compensation film
225 High refractive index film
226 Low refractive index film
227 Planarization film
230 Microlens layer
231 Microlens
231 Filling layer
300 Liquid crystal material layer
301 Liquid crystal molecule
400 Seal portion
PX Pixel
SCL Scanning line
DTL Signal line
TR Transistor
CS Capacitance structure
MK1, MK2, MK3 Mask
OP1, OP2, OP3 Opening
GV1, GV2, GV3 Groove
SL1, SL2, SL3 Inclined surface
500 Light source section
510 Illumination optical system
520 Image control circuit
530 Projection optical system
540 Screen
611 Camera body
612 Imaging lens unit
613 Grip portion
614 Monitor
615 Viewfinder
711 Eyeglass-shaped display section
712 Ear hooking portion
800 Eyeglasses
811 See-through head mounted display
812 Main body
813 Arm
814 Lens barrel

1. A liquid crystal display device comprising:
a pair of substrates;
a liquid crystal material layer sandwiched between the pair of substrates; and
an optical compensation element having an optical compensation film, wherein
the optical compensation element includes: a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

2. The liquid crystal display device according to claim 1, wherein
each of the high refractive index film and the low refractive index film includes an inorganic insulating material.

3. The liquid crystal display device according to claim 2, wherein
each of the high refractive index film and the low refractive index film includes any one of silicon oxide, silicon nitride, and silicon oxynitride.

4. The liquid crystal display device according to claim 1, wherein
an arrangement pitch of the set of the plurality of grooves having different depths is 300 nanometers or less.

5. The liquid crystal display device according to claim 1, wherein
a part of the base layer is periodically removed such that an arrangement pitch of the base layer is shorter than an arrangement pitch of the set of the plurality of grooves having different depths.

6. The liquid crystal display device according to claim 1, comprising
a transistor array substrate and a counter substrate that is disposed so as to face the transistor array substrate, as the pair of substrates.

7. The liquid crystal display device according to claim 6, wherein
the optical compensation element is disposed in at least one of the counter substrate or the transistor array substrate.

8. The liquid crystal display device according to claim 6, wherein
a black matrix and/or a microlens are/is formed in at least one of the counter substrate or the transistor array substrate.

9. An optical compensation element comprising:
a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.

10. A method for manufacturing an optical compensation element, comprising:
a step of forming a set of a plurality of grooves having different depths on a surface of a base body at a predetermined pitch;
a step of, subsequently, repeatedly performing a film forming process and an etching process on the surface to form a base layer having a serrated cross-sectional shape; and
a step of alternately forming a high refractive index film and a low refractive index film on the base layer to form an optical compensation film.

11. The method for manufacturing an optical compensation element according to claim 10, wherein
the step of repeatedly performing a film forming process and an etching process on the surface to form a base layer having a serrated cross-sectional shape is performed by performing high density plasma CVD on the surface.

12. The method for manufacturing an optical compensation element according to claim 10, further comprising
a step of periodically removing a part of the base layer such that an arrangement pitch of the base layer is shorter than an arrangement pitch of the set of the plurality of grooves having different depths.

13. An electronic apparatus comprising a liquid crystal display device including:
a pair of substrates;
a liquid crystal material layer sandwiched between the pair of substrates; and
an optical compensation element having an optical compensation film, wherein
the optical compensation element includes: a base layer having a serrated cross-sectional shape formed by repeatedly performing a film forming process and an etching process on a surface on which a set of a plurality of grooves having different depths is formed at a predetermined pitch; and an optical compensation film in which a high refractive index film and a low refractive index film are alternately formed on the base layer.
